(19) United States
(12) Patent Application Publication
(10) Pub. No.: US 2002/0195800 A1
(43) Pub. Date: Dec. 26, 2002

(54) Airbag module

(76) Inventor: Stefan Florsheimer, Florsheim (DE)

Correspondence Address: BREED AUTOMOTIVE TECHNOLOGY, INC, 5300 ALLEN K BREED HIGHWAY, P O BOX 33050, LAKELAND, FL, 33807-3050, US

(21) Appl. No.: 09/988,639

(22) Filed: Nov. 20, 2001

(30) Foreign Application Priority Data
Jun. 26, 2001 (DE) 10130715.2

(51) Int. Cl. B60R 21/16

(52) U.S. Cl. 280/728.3; 280/728.2; 280/743.1

(57) ABSTRACT

An airbag module has an airbag, a source of inflation gas and a cover. The cover has a plurality of breaking lines therein that define a plurality of adjacent flaps for opening the cover when the airbag is deployed. At least some of the breaking lines extend essentially parallel to one another and define a plurality of individual flaps that extend essentially parallel to one another.

### FIELD OF THE INVENTION

The present invention relates to an airbag module as well as a cover for an airbag module.

### BACKGROUND OF THE INVENTION

Until now, airbag modules, in particular passenger side airbag modules, have generally been covered by two stiff flaps. The two stiff flaps are usually covered on the outside by a foil, which forms the vehicle interior. The outer cover layer, that is to say the foil, generally has an essentially H-shaped or U-shaped breaking line with a generally horizontally projecting main breaking line, extending parallel to both flaps along their line of contact. On both ends of this main breaking line, two shorter breaking lines are arranged essentially perpendicular thereto. If the airbag is deployed, the cover tears open along the breaking lines and both flaps are pushed outwards to release the airbag. Because the large cover elements need to be opened a relatively significant opening force is required.

The cover for an airbag module according to the invention has a plurality of breaking lines therein that define a plurality of adjacent flaps for the opening of the cover. The airbag door or the opening parts of the cover are divided into a plurality of individual flaps or tabs that fold to the side. This enables a smoother opening or tearing open of the cover when an airbag positioned behind it is inflated. It does not have to be the case that one large breaking line suddenly tears open under a significant force action, but rather a plurality of small breaking lines can open or tear open to create an opening in the cover through which the airbag can emerge. The adjacent flaps are in each case much smaller than the large flaps or cover parts of known airbag modules and require less force to be torn open.

### BRIEF DESCRIPTION OF THE DRAWINGS

FIG. 1 shows a first arrangement of the breaking lines in an airbag cover according to the invention.

FIG. 2 is a second possible arrangement of the breaking lines in an airbag cover according to the invention.

FIG. 3 is a third possible arrangement of the breaking lines in an airbag cover according to the invention.

FIG. 4 is a cross section through a preferred embodiment of an airbag module according to the invention.

### DETAILED DESCRIPTION OF THE INVENTION

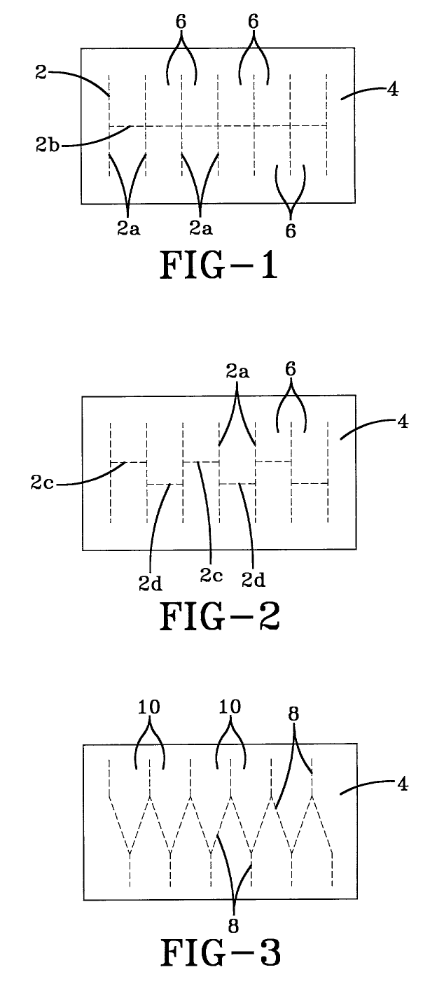

FIG. 1 is a diagrammatic representation of the arrangement of the breaking lines 2 in a cover 4 for an airbag module. In this case the cover 4 can be a separate element or be part of an entire vehicle interior lining. The breaking lines 2 comprise a plurality of parallel breaking lines 2a and a breaking line 2b extending essentially perpendicularly to the breaking lines 2a. In this way a plurality of flaps 6 is defined, which are enclosed by the breaking lines 2a, 2b in a U-shape. The flaps or tabs 6 are arranged opposite each other in two rows, whereby in each case two opposite flaps are separated from one another by the breaking line 2b. Preferably, for instance in the use for a passenger seat airbag module, the breaking lines 2a, 2b are arranged in the represented manner, so that the breaking line 2b extends essentially horizontally, whereas the breaking lines 2b extend essentially vertically. If an airbag module, which is located under the cover 4, is activated the airbag is inflated and generates a force onto the cover 4. The breaking lines 2a, 2b tear open and the flaps 6 outwardly fold open. The flaps which are opposite each other unfold in opposite directions and release an essentially rectangular escape opening for the airbag. The breaking lines 2a, 2b can be placed in the material of the cover 4 in the shape of perforations, notches, recesses or in any other material-weakening way.

It is preferred that five, preferably six or more individual flaps are defined by the breaking lines. The opening in the cover, which must tear open during the deployment of the airbag, is of a certain minimum size to enable a sufficiently rapid escape of the airbag. The more individual, preferably adjacent breaking lines that are located in the region of the opening, the more individual flaps or tabs are created when the cover tears open during the deployment of the airbag. It is advantageous that as many individual flaps or tabs as possible are created, so that the cover tears open as smoothly as possible similarly to a foil. The possibility exists that during the inflation of the airbag the individual breaking lines do not tear open simultaneously, but successively, thereby enabling a very smooth and even escape of the airbag out of the cover.

FIG. 2 shows a variation of the embodiment according to FIG. 1. Here a plurality of breaking lines 2a are also arranged parallel to one another. It is further preferred that at least one breaking line extends essentially offset from the other breaking lines, in each case between two breaking lines 2a, shorter breaking lines 2c, 2d extend essentially perpendicular to the breaking lines 2a similarly to the breaking line 2b from FIG. 1. The breaking lines 2c, 2d are however, always arranged alternatively between the breaking lines 2a and in the longitudinal direction of the breaking lines 2a they are offset in such a manner that the breaking lines 2c, 2d form a graduated line. In this way a longer tab or flap 6 is always opposite a shorter tab or flap 6, whereby in the two rows of flaps 6 the shorter and the longer flaps 6 alternate in each case. In this way a very easy tearing open of the cover and a rapid escape of the airbag is enabled, since the unfolding paths of the individual flaps and tabs are very short. The flaps in the two opposite rows are arranged offset to each other.

As shown in FIGS. 1 and 2 the breaking lines may be arranged in such a way that two opposite rows are defined by a plurality of flaps, whereby in each case at least two opposite flaps come into contact in a breaking line. In such an arrangement several essentially rectangular flap lie next to each other. Two rows of adjoining or adjacent flaps or tabs are defined, which fold open to two opposite directions. Such an arrangement is particularly suitable for an airbag module in which a rectangular opening is to be created, such as a passenger, side or knee protection airbag module.

FIG. 3 shows a further variation, in which breaking lines 8 are arranged to define a plurality of angular tabs or flaps 10. The flaps 10 extend essentially parallel to each other and are arranged in two rows opposite each other. In this case the flaps 10 in both rows are offset with regard to each other in such a manner that the tip of a flap 10 of the first row lies between two tips of two flaps of the opposite row of flaps 10. In the middle between the two rows of flaps 10, a zigzag-shaped breaking line is thus achieved. In this embodiment the flaps or tabs 10 unfold during the tearing open of the breaking lines 8 in opposite directions, so that an essentially rectangular-shaped escape opening is released for an airbag.

The arrangements of the breaking lines 2, 8 are merely shown by way of example and a plurality of arrangements is conceivable. The basic principle of the invention lies in the fact that a high number of individual flaps 6, 10 are defined by breaking lines. In the represented embodiments, 11 or 12 individual flaps are foreseen. It is however also possible to foresee even more individual flaps or tabs 6, 10. It is preferable to have a number of tabs or flaps higher than six. In the shown examples, the flaps or tabs 6, 10 are arranged in two rows opposite and parallel to each other. It is also possible, however, to arrange the flaps or tabs in a circular manner, so that they extend from each other like the segments of a circle and that the breaking lines extend towards each other in a star-shaped manner and essentially meet in a common central point. Such an embodiment is preferred in a round airbag module with a round escape opening for the airbag. In a square escape opening it can also be preferable to arrange the tabs in such a manner that at least one part of the tabs extends in an angular or triangular manner and that at least one part of the breaking lines preferably intersect in one common point. Such arrangements of tabs and flaps, which are formed by a plurality of breaking lines, can be described as essentially annular-shaped. It is essential that the individual flaps or tabs are preferably kept as small as possible, so that they display only a minor mass and therefore reduced energy during the opening. A large escape opening should be defined by a plurality of breaking lines or tabs and flaps in the cover.

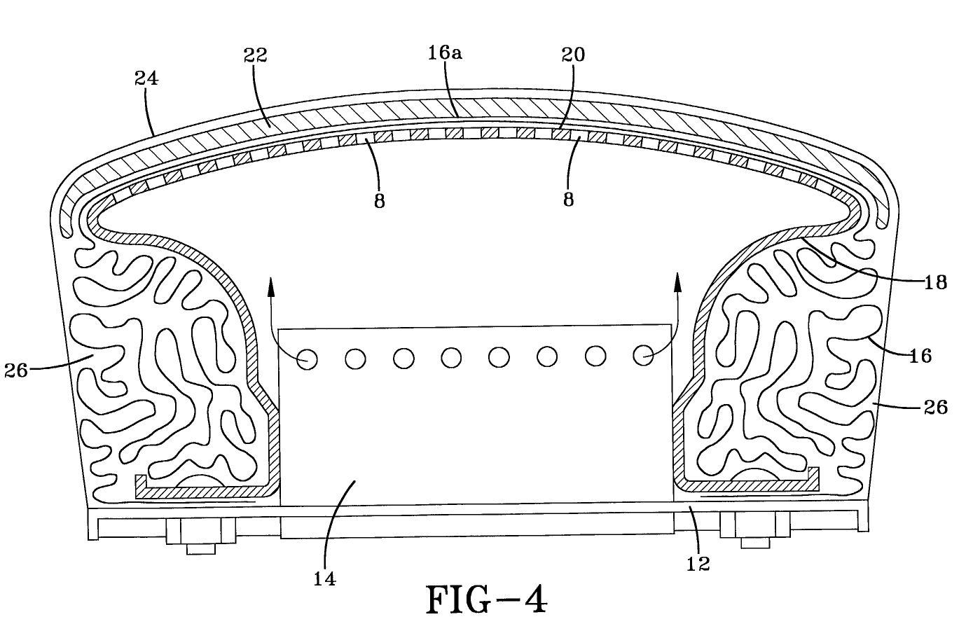

FIG. 4 shows a cross section through a preferred embodiment of an airbag module according to the invention. Similar to known airbag modules, the airbag module comprises a carrier or a holding plate 12 with a source of inflation gas such as a gas generator 14 secured thereto as well as an airbag 16. It is understood that the source of inflation gas could alternatively be a stored gas inflator or a hybrid inflator. In addition the airbag module comprises a carrier element 18, which surrounds the gas generator 14 like a cage and extends in a mushroom-shaped manner from the gas generator 14. The front surface 20 of the carrier element 18 is thereby turned towards the vehicle interior and points towards the unfolding direction of the airbag. The unfolding direction is the direction in which the airbag moves towards a vehicle occupant during its inflation with a gas. Towards the rear, i.e. towards the end of the airbag turned away from the vehicle interior, the carrier element is tapered in such a way that it lies adjacent to, or surrounds, the gas generator. In this way gas generated by the gas generator can flow only through the carrier element and preferably only through the carrier element's gas permeable front surface. The carrier element preferably can absorb energy into itself in order to act as an additional impact protection, for instance when the airbag does not unfold. The front surface can be slightly convex towards the vehicle interior. The carrier element is preferably one piece. If the carrier element has a complex shape, it may comprise several parts that are preferably made of sheet metal or synthetic material, and are preferably welded together.

Preferably on at least its front surface, the carrier element is gas permeable, in particular in the shape of a perforated plate. This configuration enables the gas that is supplied by the gas generator to flow through the carrier element to inflate the airbag. The configuration as a perforated plate is cost-effective to produce and provides a desired deformability of the carrier element. In addition, through a purposeful arrangement of openings or holes in the carrier element, the gas flow can be directed into a desired direction. Instead of the configuration of the carrier element as a perforated plate, the carrier element can also be made of gas permeable synthetic material. At least the front surface of the carrier element is deformable in such that during the inflation of the airbag the carrier element bulges into the unfolding direction of the airbag. The carrier element may be made deformable by a perforated plate or synthetic material.

Preferably the front surface of the carrier element, to which the airbag is adjacent, extends essentially along the entire front side of the airbag module. The front side of the airbag module is the side of the airbag module that is faces towards the vehicle interior of a motor vehicle. The front surface of the carrier element covers the airbag module preferably essentially entirely, whereby merely a front section of the airbag is located above the carrier element, i.e. towards the vehicle interior. The front section of the airbag corresponds to the section that during the unfolding of the airbag extends towards a vehicle occupant. Due to the carrier element, the airbag module has a stable surface towards the vehicle interior, on the one hand forming the desired contour of a vehicle interior lining and on the other hand reliably protecting the airbag module from damage. This configuration enables a very thin design of the cover, as it essentially does not have to fulfil any significant carrier function. In addition, this configuration favors the arrangement of a plurality of breaking lines, since these weaken the cover in terms of its stability. This is, however, unproblematic, since the underlying carrier element ensures a sufficient stability of the entire arrangement. Preferably, only one layer of the folded airbag, namely the front section, is positioned in the unfolding direction in front of the carrier element. The carrier element offers back support to the front layer of the airbag, which in the folded state of the airbag forms the front surface of the airbag module, so that the airbag module comprises a stable front or outer surface. The carrier element preferably has a configuration of the type that it is inserted into the shape of a vehicle interior lining. Such an airbag module is particularly suitable for installing into the passenger side, since airbag modules of this type are very large and also require a large opening. At the same time, however, the instrument panel has to be sufficiently stable and strong, which is ensured by the carrier element.

The airbag 16 is secured in the region of its gas entry opening between the gas generator carrier 12 and the carrier element 18. A frontal or front section 16a of the airbag 16, which is turned towards the vehicle occupant in the unfolded state of the airbag, is directly adjacent to the side of the front surface 20 turned towards the vehicle interior. Above the front section 16a of the airbag 16, i.e. towards the vehicle interior, a foam element 22 is arranged on the front surface 20. The foam element 22 is covered by a cover foil 24. The cover foil 24 surrounds the entire airbag module and is attached to the circumference of the holding plate 12. In this way a good level of protection is achieved for the entire airbag module and in particular the airbag 16. The cover preferably comprises at least on its outside a foil or a layer of fabric or leather. In this way a very smooth outer side can be created which is preferably adjusted to the design of a vehicle interior. The breaking lines are preferably on the reverse side of the cover, so that they are not visible from the vehicle interior. The breaking lines in the shape of notches or recesses can be formed directly in the outer part of the cover, i.e. in the foil or the layer of fabric or leather. The cover foil 24 has a structure adjusted to the rest of the vehicle interior lining, so that it can be part of the vehicle interior lining, without further cover elements needing to be located over the airbag module. This enables a more rapid unfolding of the airbag. In this way an improved level of protection of a vehicle occupant can be ensured. The foam element 22 provides a certain cushioning effect of the surface of the airbag module, which ensures additional protection against collisions and creates a pleasant-to-touch surface. On the side of the carrier element that faces towards the vehicle interior, merely one layer of the airbag, which forms a front section, is located. The airbag 16 is preferably folded in a chaotic manner in the side regions 26, which surround the tapered or narrower part of the carrier element 18 in the region of the gas generator 14 behind the front surface of the carrier element. In this way the folded airbag is well protected by the carrier element. In addition, the carrier element forms a stable surface of the airbag module towards the vehicle interior. The front surface 20 of the carrier element 18 comprises a plurality of holes 28 that enable gas created by the gas generator 14 to escape. Because the carrier element 18 is located directly under the surface of the airbag module, which is formed by the front section 16a of the airbag 16, the foam element 22 and the cover foil 24, the surface has sufficient stability, so that additional flaps over the airbag module in the vehicle can be dispensed with. The airbag module can be visibly arranged directly on the surface of a vehicle interior lining or invisibly behind the surface. The carrier element can comprise a very thin and light synthetic material. If under an outer cover, which for instance comprises a foil or a layer of fabric or leather, additional elements, such as a carrier and a foam element, the breaking lines in these elements are preferably correspondingly designed, so that the latter tear open at the same time as the outer layer and thus create a plurality of flaps or tabs.

To unfold the airbag, the gas generator 14 is activated, so that the gas, as shown in FIG. 4 with arrows, flows from the gas generator into the inside of the carrier element 18. The gas flows through the holes 28 into the carrier element 18 and drives the front section 16a of the airbag 16 which lies adjacent to the front surface 20 in the direction of the vehicle interior.

The front section 16a of the airbag 16 pushes against the foam element 22 and the cover foil 24, whereby the cover foil 24 will preferably tear open along the breaking lines 2, 8, which are not represented, as described above, so that the airbag 6 can eject into the vehicle interior in an unimpeded manner. The breaking lines 2, 8 in the cover foil 24 and the foam element 22, are similar to the previous examples. In this case the cover foil 24 and the foam element 22 form the cover 4 according to the previously described examples. Due to the carrier element 18, the foam element 22 and the cover foil 24 are supported, so that the cover 4 can be very easily designed, as it has no carrier function as in conventional airbags. The foam element 22 can be dispensed with in alternative embodiments. In addition, under the cover 24 or, in the event that a foam element 22 is used, under the latter, a further reinforcing layer, for instance out of a synthetic material, can be foreseen, which gives additional stability to the cover 4. Due to the carrier element 18, this can be made significantly lighter and thinner than the conventional rigid flaps of airbag modules. Overall, therefore, a very light cover 4 can be created, which on the basis of the plurality of breaking lines 2, 8, as shown in FIGS. 1 to 3, tears open in such a way that several little tabs or flaps 10 are created, which ensure a smooth tearing open, similarly to a foil. In the airbag module shown in FIG. 4, the cover, comprising the foam element 22 and the cover foil 24, is integrated in the airbag module as a separate component. Alternatively, the cover 4 can also be an integral component of a vehicle interior lining, behind which the other components of the airbag module are located. In this way a seamless surface of a vehicle interior lining can be created. The breaking lines are preferably in the shape of notches or recesses on the inside of the cover, i.e. of the foam element 22 and the cover foil 24. The inner side is the side that is turned toward the gas generator 14. In this way the cover foil 24 forms a seamless surface on its outside which is turned towards the vehicle interior, with no breaking lines visible. The cover foil 24 can comprise a synthetic material, or alternatively materials such as fabric or leather are conceivable depending on the desired vehicle design.

The carrier element 18 and in particular its front surface 20 can, in addition, bulge into its inside through the gas pressure during the activation of the gas generator. The front surface 20 in this case arches in the direction of the vehicle interior. At the same time the carrier element pulls together its circumference, i.e. the circumference is reduced. This enables the airbag 16 folded in the side regions 26 to move more easily along the circumference of the carrier element 18, as a larger free space is created. This ensures a rapid unfolding of the airbag 16. This deforming of the carrier element 18 leads to the front surface 20 of the carrier element 18, in the folded state of the airbag, nearly completely covering the airbag module towards the vehicle interior and at the same time, during the unfolding of the airbag 16, it creates a gap at the circumference of the front surface 10 of the carrier element 18, through which the airbag 16 can unfold in an unimpeded manner.

A cover layer 24 may advantageously completely cover the airbag module and is secured to the gas generator or a gas generator carrier. The airbag module is thus protected from damage before the installation in a motor vehicle. Alternatively, the cover layer can also be directly stuck on the airbag in the region of its front section. In this case during the unfolding of the airbag the cover layer moves together with the front section of the airbag towards a vehicle occupant. It is preferred that the cover forms an outer part of the airbag module, that is turned towards the vehicle interior, without the need to arrange additional heavy cover elements, such as strong cover flaps, over the airbag module. The cover material is selected harmoniously fit in with the rest of the vehicle interior. It is preferred that the cover layer a foil or another surface material, which covers the entire vehicle interior lining, as for instance the instrument panel. This enables a seamless surface of the vehicle interior lining in those regions in which airbag modules are located. Nevertheless a very rapid unfolding of the airbag can be ensured, since the latter is not located behind strong cover flaps, but rather directly under the foil or material layer forming the surface of the vehicle interior lining.

The airbag module described with reference to FIG. 4 is also merely an example and the arrangement of the breaking lines 2, 8 according to the invention, as described by way of example with reference to FIGS. 1 to 3, can also be used in connection with other airbag modules. Despite it being preferable, the arrangement of a carrier element 18 is not necessarily required.

Many changes and modifications in the above described embodiments of the invention can, of course, be carried out without departing from the scope thereof. Accordingly, that scope is intended to be limited only by the scope of the appended claims.

I claim:

1. An airbag module comprising an airbag, a source of inflation gas and a cover having therein a plurality of breaking lines that define a plurality of adjacent flaps for opening the cover, at least some of the breaking lines extend essentially parallel to one another and define a plurality of individual flaps that extend essentially parallel to one another.

2. The airbag module according to claim 1 wherein a carrier element is arranged in a direction in which the airbag unfolds between the source of inflation gas and the airbag in such a way that a section of the airbag in its folded state lies adjacent to a front surface of the carrier element in an essentially flat manner and that the cover with the breaking lines lies adjacent to this section of the airbag opposite the carrier element.

3. The airbag module according to claim 2 wherein the carrier element extends essentially along the entire front side of the airbag module.

4. The airbag module according to claim 2 wherein a front surface of the carrier element is gas permeable.

5. The airbag module according to claim 3 wherein a front surface of the carrier element is gas permeable.

6. The airbag module according to claim 2 wherein the carrier element includes a perforated plate.

7. The airbag module according to claim 3 wherein the carrier element includes a perforated plate.

8. A cover for an airbag module, said cover having therein a plurality of breaking lines that define a plurality of adjacent flaps for opening the cover, at least some of the breaking lines extend essentially parallel to one another and define a plurality of individual flaps that extend essentially parallel to one another.

9. The cover for an airbag module according to claim 8 having at least five flaps defined by the breaking lines.

10. The cover for an airbag module according to claim 8 wherein at least part of the breaking lines extend at an angle with respect to one another.

11. The cover for an airbag module according to claim 8 wherein at least one breaking line extends offset from other breaking lines that extend parallel thereto.

12. The cover for an airbag module according to claim 8 wherein the breaking lines are arranged in two defining a plurality of flaps whereby at least two opposite flaps adjoin a breaking line.

13. The cover for an airbag module according to claim 12 wherein the flaps are arranged in an offset manner with respect to one another in the two rows.

14. The cover for an airbag module according to claim 8 wherein the cover has an outer surface layer comprising a foil.

15. The cover for an airbag module according to claim 8 wherein the cover has an outer surface layer comprising a layer of fabric.

16. The cover for an airbag module according to claim 8 wherein the cover has an outer surface layer comprising a layer of leather.

17. The cover for an airbag module according to claim 8 further comprising a foam element.
